(19) United States
(12) Patent Application Publication
(10) Pub. No.: US 2018/0195402 A1
(43) Pub. Date: Jul. 12, 2018

(54) DISPOSABLE FAN PLATFORM FAIRING

(71) Applicant: UNITED TECHNOLOGIES CORPORATION, Farmington, CT (US)

(72) Inventors: Matthew A. Turner, Wallingford, CT (US); Andrew G. Alarcon, Manchester, CT (US); Shari L. Bugaj, Haddam, CT (US)

(21) Appl. No.: 15/116,713

(22) PCT Filed: Dec. 11, 2014
(86) PCT No.: PCT/US2014/069774

§ 371 Date: Aug. 4, 2016

Related U.S. Application Data
(60) Provisional application No. 61/935,969, filed on Feb. 5, 2014.

(51) Int. Cl. F01D 11/00; F02K 3/06; F04D 29/32; F01D 25/00

(52) U.S. Cl. CPC F01D 11/008; F02K 3/06; F04D 29/329; F01D 25/005; F05D 2220/323; F05D 2300/436; F05D 2230/20; F05D 2230/80; F05D 2240/80; F05D 2220/36; F05D 2300/434; F05D 2230/31

(57) ABSTRACT

A fan assembly for a gas turbine engine is disclosed. The fan assembly may include a rotor, a plurality of airfoils extending radially from the rotor, and a platform surrounding the rotor and including a surface that defines a flow path between the plurality of airfoils. The platform may be configured to be disposable during a life of the gas turbine engine.

### CROSS-REFERENCE TO RELATED APPLICATION

This is a Non-Provisional Patent Application claiming priority under 35 U.S.C. § 119(e) to U.S. Provisional Patent Application No. 61/935,969 filed on Feb. 5, 2014.

### FIELD OF THE DISCLOSURE

The present disclosure relates generally to gas turbine engines and, more particularly, to fan platforms in a gas turbine engine.

### BACKGROUND OF THE DISCLOSURE

Gas turbine engines may typically include a fan, a compressor, a combustor, and a turbine, with an annular flow path extending axially through each. Initially, the fan, which is powered by the turbine, draws ambient air into the engine. Part of the air flows through the compressor where it is compressed or pressurized. The combustor then mixes and ignites the compressed air with fuel, generating hot combustion gases. These hot combustion gases are then directed from the combustor to the turbine where power is extracted from the hot gases by causing blades of the turbine to rotate. The other part of the airflow from the fan is used to generate forward thrust.

A fan assembly of the gas turbine engine may include a plurality of blades extending radially from a central rotor. The plurality of blades may be circumferentially spaced apart around the rotor. Surrounding the rotor, a fan platform may extend between each of the plurality of blades. The fan platform may include a surface defining a flow path for the airflow through the fan assembly. typically designed to have a high strain rate to failure capability. In addition, prior art fan platforms are designed to last an entire life of the gas turbine engine.

Manufacturing life-of-engine fan platforms with high strain rate to failure capability may be expensive. For example, typical fan platforms may be made of high cost materials, such as, aluminum, titanium, metal, or composite material. Furthermore, repairing FOD on the fan platform and returning the fan platform into the gas turbine engine may not only be a labor-intensive process, it may be time-consuming as well. Accordingly, there exists a need for a cost-effective fan platform, which also has an efficient FOD repair solution.

### SUMMARY OF THE DISCLOSURE

According to one embodiment, a fan assembly for a gas turbine engine is disclosed. The fan assembly may comprise a rotor, a plurality of airfoils extending radially from the rotor, and a platform surrounding the rotor and including a surface that defines a flow path between the plurality of airfoils. The platform may be configured to be disposable during a life of the gas turbine engine.

In a refinement, the platform may be composed of a sheet molding compound.

In another refinement, the platform may be composed of thermoplastic material.

In another refinement, the platform may be composed of polyetherimide.

In another refinement, the platform may be composed of polyether ether ketone.

In another refinement, the platform may be disposed of during the life of the gas turbine engine when damage is incurred.

In related refinement, the platform may be replaced with a second platform when damage is incurred.

In a related refinement, the platform may be recycled and used as material for another gas turbine engine component.

In another refinement, the platform may comprise a plurality of segments, and each segment of the plurality of segments may be individually replaceable when the segment incurs damage.

According to another embodiment, a gas turbine engine is disclosed. The gas turbine engine may comprise a fan section, a compressor section downstream of the fan section, a combustor section downstream of the compressor section, and a turbine section downstream of the combustor section. At least one of the fan section, compressor section, and turbine section may include a rotor, a plurality of airfoils extending radially from the rotor, and a platform extending between each of the plurality of airfoils and defining a flow path therebetween. The platform may have a decreased life cycle relative to a life cycle of the gas turbine engine.

In a refinement, the platform may be configured to maintain integrity from impacts up to 85 psi.

In another refinement, the platform may be composed of thermoplastic material.

In another refinement, the platform may be composed of polyetherimide.

In another refinement, the platform may be composed of polyether ether ketone.

In another refinement, the platform may be formed by injection molding.

In another refinement, the platform may be formed by compression molding.

In another refinement, the platform may be formed by additive manufacturing.

According to yet another embodiment, a method for working a fan assembly of a gas turbine engine is disclosed. The method may comprise providing a first fan platform composed of thermoplastic material in the fan assembly of the gas turbine engine; disposing of the first fan platform if the first fan platform incurs damage during operation of the gas turbine engine; and providing a second fan platform in the fan assembly of the gas turbine engine.

In a refinement, the method may further comprise forming the first fan platform from at least one of injection molding, compression molding, or additive manufacturing.

In another refinement, the method may further comprise recycling the first fan platform into material for another gas turbine engine component.

These and other aspects and features of the disclosure will become more readily apparent upon reading the following detailed description when taken in conjunction with the accompanying drawings. Although various features are disclosed in relation to specific exemplary embodiments of the invention, it is understood that the various features may be combined with each other, or used alone, with any of the various exemplary embodiments of the invention without departing from the scope of the invention.

### BRIEF DESCRIPTION OF THE DRAWINGS

FIG. 1 is a cross-sectional view of a gas turbine engine, according to an embodiment of the present disclosure;

FIG. 2 is a cross-sectional view of a fan assembly in a fan section of the gas turbine engine of FIG. 1;

FIG. 3 is a side view of a fan platform, according to an embodiment of the present disclosure;

FIG. 4 is a perspective view of a fan assembly according to an embodiment of the present disclosure;

FIG. 5 is a perspective view of a fan assembly according to an embodiment of the present disclosure; and

FIG. 6 is a flowchart illustrating an exemplary process for a fan assembly of a gas turbine engine, according to another embodiment of the present disclosure.

While the present disclosure is susceptible to various modifications and alternative constructions, certain illustrative embodiments thereof will be shown and described below in detail. The invention is not limited to the specific embodiments disclosed, but instead includes all modifications, alternative constructions, and equivalents thereof.

### DETAILED DESCRIPTION

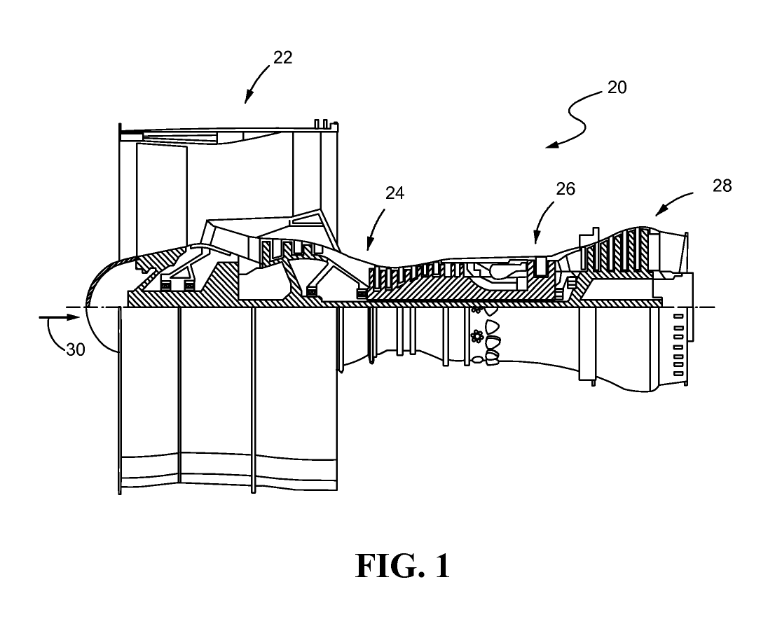

Referring now to the drawings, and with specific reference to FIG. 1, in accordance with the teachings of the disclosure, an exemplary gas turbine engine 20 is shown. The gas turbine engine 20 may generally comprise a fan section 22 which draws ambient air into the engine 20, a compressor section 24 where air is pressurized, a combustor 26 downstream of the compressor section which mixes and ignites the compressed air with fuel and thereby generates hot combustion gases, a turbine section 28 downstream of the combustor 26 for extracting power from the hot combustion gases, and an annular flow path 30 extending axially through each. Gas turbine engine 20 may be used on an aircraft for generating thrust or power, or in land-based operations for generating power as well.

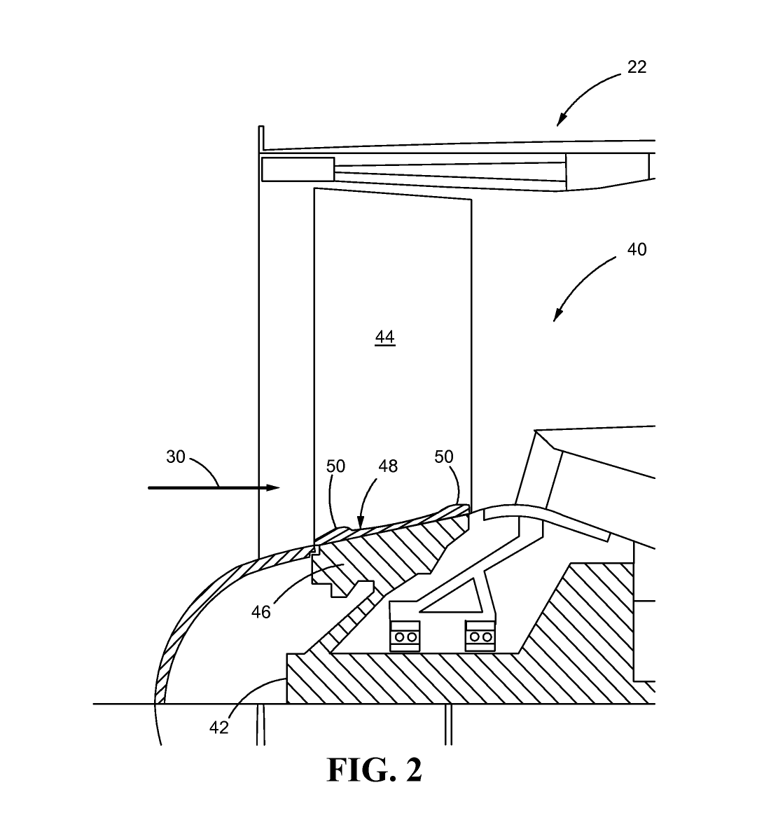

Turning now to FIGS. 2-5, with continued reference to FIG. 1, a fan assembly 40 of the gas turbine engine 20 is shown, according to an embodiment of the present disclosure. The fan assembly 40 may comprise a rotor 42 and a plurality of airfoils 44 extending radially therefrom. The plurality of airfoils 44 may be circumferentially spaced apart around the rotor 42. A fairing or platform 46 may surround the rotor 44 and include a surface 48, which defines at least part of the flow path 30. The surface 48 may include one or more curvatures 50 to aerodynamically direct airflow and reduce drag through the flow path 30. The platform 46 may be attached to the rotor 42 and/or to the plurality of airfoils 44, although other means of attachment are certainly possible.

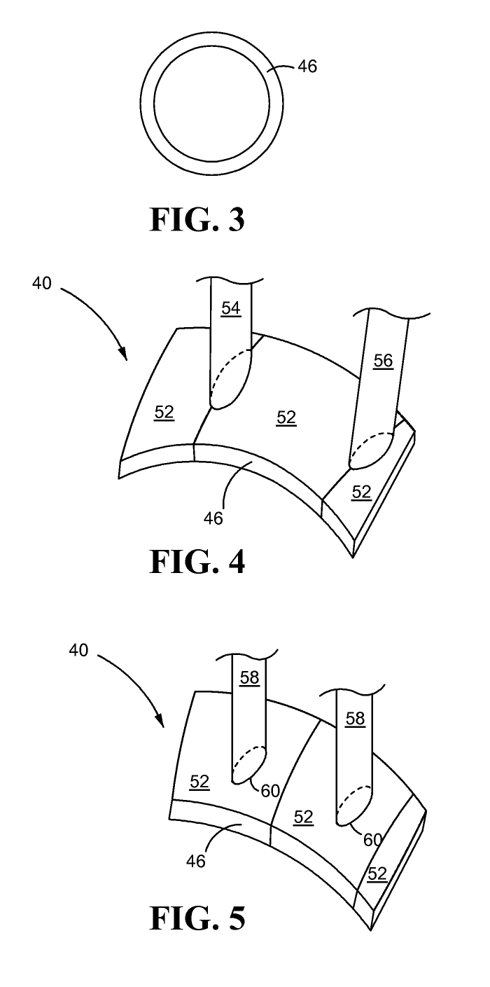

As shown best in FIG. 3, the platform 46 may comprise a single annulus. Alternatively, the platform 46 may be comprised of a plurality of segments 52, as shown best in FIGS. 4 and 5. As shown in FIG. 4, each segment 52 of the platform 46 may extend from a first airfoil 54 to a second adjacent airfoil 56. As shown in FIG. 5, each segment 52 of the platform 46 may encompass one airfoil 58, including an aperture 60 therefor. It is to be understood that other configurations for the plurality of segments 52 than that shown in FIGS. 4 and 5, are certainly possible. For example, each segment 52 may encompass two or more airfoils.

The platform 46 may be configured to be consumable or disposable during a life of the gas turbine engine 20. As used herein, the term “consumable” means “intended to be used and then replaced”. As used herein, the term “disposable” means “designed to be disposed of or recycled after use”. More specifically, the platform 46 may have a decreased life cycle relative to a life cycle of the gas turbine engine 20 such that the platform 46 does not have a life capability of the entire engine cycle. The platform 46 may be designed to meet standard industry performance requirements, while having reduced fatigue or endurance characteristics compared to prior art platforms. For example, the platform 46 may have a reduced strain rate to failure capability relative to a strain rate to failure capability of prior art platforms. In another example, the platform 46 may be configured to maintain structural integrity during standard revolutions of the rotor 42, and the platform 46 may be configured to maintain integrity from impacts up to 85 psi.

In so doing, the platform 46 may be removed from the engine 20 and disposed of when the platform 46 incurs damage during the life of the gas turbine engine 20. The platform 46, or any individual segment(s) 52 of the platform 46, which has incurred damage during operation of the gas turbine engine 20, may then be replaced with another platform or segment 52, which has no damage. For example, when the gas turbine engine 20 goes through a routine overhaul or examination, the damaged platform may be disposed of and replaced with a new platform instead of undergoing a repair process.

Various processes may be used to form the platform 46, such as, without limitation, injection molding, compression molding, and additive manufacturing. The platform 46 may be composed of a sheet molding compound, a thermoplastic resin with thermoset fillers, and the like. In an embodiment, the platform 46 may be composed of thermoplastic material, such as, without limitation, polyetherimide, polyether ether ketone, and the like. Thermoplastic material is moldable above a specific temperature, returns to a solid state upon cooling, and may be re-molded again without undergoing irreversible chemical change during a curing process. After the platform 46 is removed from the engine 20 or disposed of, the platform 46 may then be recycled and used as starting material, e.g., for another gas turbine engine component.

It is to be understood that other consumable materials than thermoplastics, or combinations thereof, may be used for the platform 46. For example, the platform 46 may be composed of a wooden material (e.g., balsa). Furthermore, the platform 46 may have a coating applied over the consumable material. Although the platform 46 is shown and described as part of the fan assembly 40 in the fan section 22 of the gas turbine engine 20, the platform 46 may also be used as a platform within the compressor section 24 or turbine section 28.

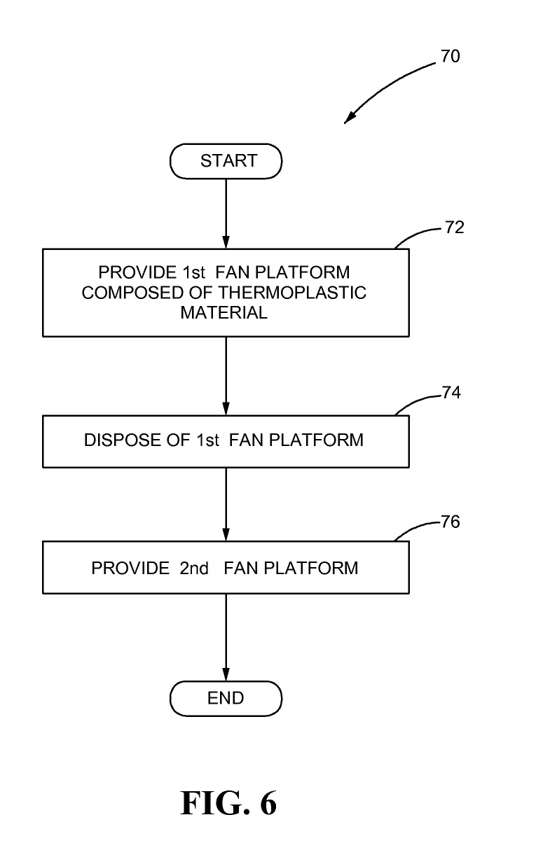

Turning now to FIG. 6, with continued reference to FIGS. 1-5, a flowchart outlining a process 70 for working the fan assembly 40 of the gas turbine engine 20 is shown, according to another embodiment of the present disclosure. At a block 72, a first fan platform composed of thermoplastic material may be provided in the fan assembly 40 of the gas turbine engine 20. If the first fan platform incurs damage during operation of the gas turbine engine, the first fan platform may be disposed of, at a block 74. At a block 76, a second fan platform may be provided in the fan assembly 40 of the gas turbine engine 20. The gas turbine engine may then be operated with the second fan platform installed.

### INDUSTRIAL APPLICABILITY

From the foregoing, it can be seen that the teachings of this disclosure can find industrial application in any number of different situations, including but not limited to, gas turbine engines. Such engines may be used, for example, on aircraft for generating thrust, or in land, marine, or aircraft applications for generating power.

The present disclosure provides a disposable fan platform and method for working a fan assembly of a gas turbine engine. By integrating a fan platform that has a decreased life cycle compared to a life cycle of the gas turbine engine (but still meets short term performance requirements), the present disclosure presents significant improvements over the prior art fan platforms which were built to last the entire life cycle of the gas turbine engine. First, a drastically reduced cost structure is achieved due to the consumable or disposable materials (e.g., thermoplastic material) used for the fan platform. Not only is it less expensive to manufacture the disclosed platform, but there are also great cost savings when the platform incurs damage.

Instead of the labor-intensive and time consuming process to repair a prior art platform and return it into the gas turbine engine, the disclosed platform may be disposed of during a routine overhaul. A new disposable platform may then be quickly assembled into the same gas turbine engine to replace the damaged platform, thereby saving both time and money during the repair process. Secondly, the damaged platform may be recycled and used as starting material for another gas turbine engine component. In so doing, the disclosed platform not only has cost advantages but provides sustainability benefits as well.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed, and includes all embodiments and equivalents encompassed within the claims appended hereto as well.

What is claimed is:

1. A fan assembly for a gas turbine engine, comprising:
a rotor;
a plurality of airfoils extending radially from the rotor; and
a platform surrounding the rotor and including a surface that defines a flow path between the plurality of airfoils, the platform configured to be disposable during a life of the gas turbine engine.

2. The fan assembly of claim 1, wherein the platform is composed of a sheet molding compound.

3. The fan assembly of claim 1, wherein the platform is composed of thermoplastic material.

4. The fan assembly of claim 1, wherein the platform is composed of polyetherimide.

5. The fan assembly of claim 1, wherein the platform is composed of polyether ether ketone.

6. The fan assembly of claim 1, wherein the platform is disposed of during the life of the gas turbine engine when damage is incurred.

7. The fan assembly of claim 6, wherein the platform is replaced with a second platform when damage is incurred.

8. The fan assembly of claim 7, wherein the platform is recycled and used as material for another gas turbine engine component.

9. The fan assembly of claim 1, wherein the platform comprises a plurality of segments, and wherein each segment of the plurality of segments is individually replaceable when the segment incurs damage.

10. A gas turbine engine, comprising:
a fan section;
a compressor section downstream of the fan section;
a combustor section downstream of the compressor section; and
a turbine section downstream of the combustor section, at least one of the fan section, compressor section, and turbine section including:
a rotor,
a plurality of airfoils extending radially from the rotor, and
a platform extending between each of the plurality of airfoils and defining a flow path therebetween, the platform having a decreased life cycle relative to a life cycle of the gas turbine engine.

11. The gas turbine engine of claim 10, wherein the platform is configured to maintain integrity from impacts up to 85 psi.

12. The gas turbine engine of claim 10, wherein the platform is composed of thermoplastic material.

13. The gas turbine engine of claim 10, wherein the platform is composed of polyetherimide.

14. The gas turbine engine of claim 10, wherein the platform is composed of polyether ether ketone.

15. The gas turbine engine of claim 10, wherein the platform is formed by injection molding.

16. The gas turbine engine of claim 10, wherein the platform is formed by compression molding.

17. The gas turbine engine of claim 10, wherein the platform is formed by additive manufacturing.

18. A method for working a fan assembly of a gas turbine engine, comprising:
providing a first fan platform composed of thermoplastic material in the fan assembly of the gas turbine engine;
disposing of the first fan platform if the first fan platform incurs damage during operation of the gas turbine engine; and
providing a second fan platform in the fan assembly of the gas turbine engine.

19. The method of claim 18, further comprising forming the first fan platform from at least one of injection molding, compression molding, or additive manufacturing.

20. The method of claim 18, further comprising recycling the first fan platform into material for another gas turbine engine component.
